(19) United States
(12) Patent Application Publication
(10) Pub. No.: US 2005/0241109 A1
(43) Pub. Date: Nov. 3, 2005

(54) Pan handle

(76) Inventor: Min Gyu Park, Busanjin-ku (KR)

Correspondence Address: Jerry H. Noh;Suite 2741, 3435 Wilshire Blvd., Los Angeles, CA, 90010, US

(21) Appl. No.: 11/012,988

(22) Filed: Dec. 15, 2004

(30) Foreign Application Priority Data
Apr. 1, 2004 (KR) 20-0347606

(51) Int. Cl. E05B 1/00

(52) U.S. Cl. 16/425

(57) ABSTRACT

Disclosed is an improved handle for a pan having an upper surface thereof lengthwisely recessed to form a depression with an opening formed toward a lower end of the depression. The handle having a pair of opposed wings formed outwardly extending from the sides of the handle, whereby a spatula can be seated above the handle along the depression and opening between the wings.

The present invention relates to a handle for a pan. More particularly, the present invention relates to an improved handle for a pan incorporating a seat for a spatula handle.

### BACKGROUND OF THE INVENTION

When frying foods with cooking oil in a conventional frying pan, a spatula is typically used to handle the foods being cooked therein. Once this type of cooking in the frying pan is completed, the spatula plays another role to move the cooked foods out of the pan into a dish. Then, the spatula usually loses attention from the user who places it, for example, on a cooking counter or leaves it in the frying pan. Wherever the spatula is thrown in after its use, it makes messy and greasy the specific area of the spatula making contact in the frying pan. Also, during cooking, the spatula, which has been used on the food already, while waiting to be used again, is either left on the countertop or in the frying pan. This used spatula during cooking, if placed on the countertop can leave oil and food stains on the countertop. Moreover, the cooking oil from the frying pan cooking inevitably spreads or splashes on and along the spatula handle thereby further irritating the user. Thus it is desirable to have a handle for a pan having the capacity for convenient placement of a spatula during and after cooking.

As conventional handles for pans are typically structured only for optimal gripping by a user, none of the handles known in the prior art teaches the novel handle as taught in the present invention.

### SUMMARY OF THE INVENTION

The present invention is contrived to overcome the conventional disadvantages. Accordingly, it is an object of the present invention to provide a handle for a pan incorporating a seat for a spatula. Another object is to provide a handle for a pan in a hygienic format.

To achieve these and other objects, the handle for a pan according to the present invention comprises a handle having an upper surface thereof which has a lengthwise depression. The depression is recessed further near a lower end of the handle to form an opening thereat. A wing is formed outwardly extending from each side of the handle adjacent the opening in a manner so that a spatula handle can be piled on above the depression and opening with support of the wings.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a handle according to the present invention;

FIG. 2 is a perspective view showing an application of the present invention to a frying pan and a spatula;

FIG. 3 is a side view of FIG. 1; and,

FIG. 4 is a side view of FIG. 1 cut along the 7-7 line of FIG. 1.

### DETAILED DESCRIPTION OF THE PREFERRED EMBODIMENTS

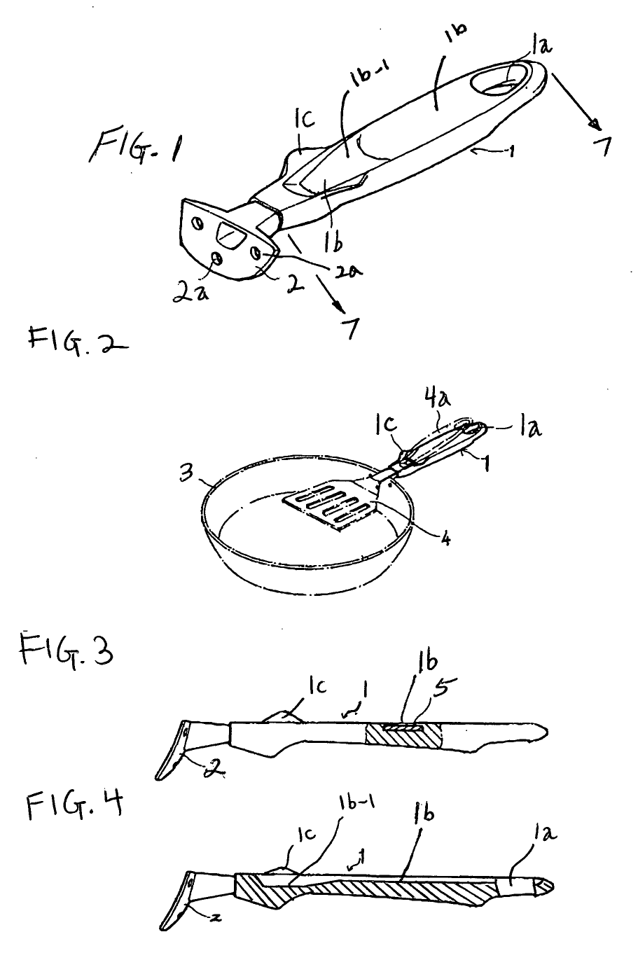

With reference to the accompanying drawings, the present invention will now be explained. As shown in FIG. 1, the handle 1 includes an engagement brace 2 by which to become attached to a frying pan 3. A plurality of openings 2a are formed through the engagement brace 2 to receive, for example, bolts to attach the handle 1 to an outer periphery of the frying pan 3. A hole 1a is formed through an upper end of the frying pan handle 1 to allow a hookup to hooks on wall surfaces when needed.

The upper side of the frying pan handle 1 is lengthwisely recessed to form a depression 1b. The depression 1b is further recessed near the lower end near the engagement brace 2 to form an opening 1b-1. A wing 1c is formed outwardly extending from each side of the handle 1 adjacent to the opening 1b-1 in a manner to allow the handle 4a of the spatula 4 to be seated lengthwise on top of the depression 1b of the handle 1 between the wings 1c.

As shown in FIG. 3, in an embodiment, a magnet 5 may be installed in an upper portion of the groove 1b in adjacency to the hook hole 1a where as a metal piece (not shown) is formed on the spatula handle 4a to facilitate attachment of the spatula handle 4a to the frying pan handle 1. Selectively, the magnet 5 may be attached to the spatula handle 4 whereas the metal piece (not shown) can be attached to the frying pan handle 1.

As discussed above, the depressed and winged construction of the handle 1 secures a safe seat by allowing the spatula handle 4 to conveniently pile up on the handle 1 of the pan when required, thereby realizing hygienic maintenance of the cooking area as well as maximizing product reliability.

Although the invention has been described in considerable detail with reference to certain illustrated versions thereof, other versions are possible by converting the aforementioned construction. Therefore, the scope of the invention shall not be limited by the specification specified above and the appended claims.

1. A handle for a pan, said handle comprising:
an upper surface, an upper end, and a lower end;
said upper surface having a lengthwise recession to form a depression; and,
a wing outwardly extending from each side of the handle.

2. The handle as described in claim 1 wherein said depression is further recessed near the lower end to form an opening.

3. The handle as described in claim 1 wherein said wings are formed on opposed sides of the handle adjacent said opening.

4. The handle as described in claim 1 wherein a magnet is disposed in the handle to allow a magnetic engagement of said magnet to a metallic member formed in a spatula handle.

5. An improved handle for a pan having the capacity to seat a spatula, said handle comprising:
an upper surface, an upper end, and a lower end;
said upper surface having a lengthwise recession to form a depression, said depression having a further recession near the lower end to form an opening;
a wing formed protruding outwardly from each side of the handle; and,
said depression, opening, and wings being formed in a manner to form a seat for a spatula.

6. The handle as described in claim 5 wherein said wings are formed on opposed sides of the handle adjacent said opening.

7. The handle as described in claim 5 wherein said spatula has a spatula handle having a metallic member and wherein a magnet is disposed in the handle to allow a magnetic engagement of said magnet to said metallic member of said spatula handle.
